(19) United States
(12) Patent Application Publication
(10) Pub. No.: US 2024/0193265 A1
(43) Pub. Date: Jun. 13, 2024

(54) Method for Protecting an Embedded Machine Learning Model

(71) Applicant: Robert Bosch GmbH, Stuttgart (DE)

(72) Inventors: Benjamin Hettwer, Stuttgart (DE); Christoph Schorn, Benningen Am Neckar (DE)

(21) Appl. No.: 18/529,714

(22) Filed: Dec. 5, 2023

(30) Foreign Application Priority Data
Dec. 9, 2022 (EP) 22212577.5

(51) Int. Cl. G06F 21/55

(52) U.S. Cl. CPC G06F 21/55

(57) ABSTRACT

A method for protecting an embedded machine learning model from at least one physical attack includes (i) ascertaining a monitoring input, wherein the monitoring input is based on at least one intermediate result from the machine learning model, (ii) evaluating the ascertained monitoring input by way of a monitoring system, and (iii) detecting the at least one physical attack on the basis of the evaluation.

This application claims priority under 35 U.S.C. § 119 to patent application no. EP 22212577.5, filed on Dec. 9, 2022 in Europe, the disclosure of which is incorporated herein by reference in its entirety.

The present disclosure relates to a method for protecting an embedded machine learning model from at least one physical attack. The disclosure also relates to a computer program and a device for this purpose.

### BACKGROUND

In the future, networked, intelligent devices will form the basis for a wide range of applications such as autonomous driving. The core of these applications are embedded machine learning (ML) models, such as deep neural networks (DNNs), which are prior art in the field of image classification, among others.

Furthermore, methods are known in the prior art to ensure the protection of embedded ML algorithms. Successful attacks on embedded machine learning algorithms have previously been demonstrated. Various features of a pre-trained DNN (i.e., number of layers, activation functions, weights, etc.) were extracted. One of the most specific types of threats with this goal are side-channel attacks, which are effective and difficult to mitigate. Physical information such as runtime, electromagnetic radiation, or the power consumption of a chip is analyzed in order to draw conclusions about the processed data. Side-channel attacks have been known in the cryptography field more than 20 years (p. 7; references are indicated at the end of this description). Recently, successful side-channel attacks on DNNs have also been demonstrated (see, e.g., [1]).

Another class of physical attack vectors from the field of cryptography are referred to as fault injection attacks. Bitflips are induced in an IC, e.g., using lasers or EM pulses, which can also be used to extract sensitive information (see [2]).

### SUMMARY

The subject matter of the disclosure is a method having the features set forth below, a computer program having the features also set forth below and a device having the features additionally set forth below. Further features and details of the disclosure are set forth below including the description and the drawings. Of course, features and details described in the context of the method according to the disclosure also apply in the context of the computer program according to the disclosure and the device according to the disclosure, and respectively vice versa, so mutual reference is or can always be made with respect to the disclosure of the individual aspects of the disclosure.

The object of the disclosure is in particular a method for protecting an embedded machine learning model (being protected) from at least one physical attack.

In this context, “embedded” can be understood to mean that the machine learning model is executed and provided by an embedded system. This can, e.g., be advantageous for the integration of the machine learning model, and thus also the embedded system, into a vehicle.

A physical attack is understood in particular to be a physical attack on the embedded system and thus at hardware level. A physical attack in the sense of the present disclosure can thereby be distinguished from a digital attack, e.g., by digital manipulation of data of the machine learning model or its inputs. Instead, the manipulation can be performed externally, e.g., by changing the temperature to generate bit errors, or there is no manipulation at data level, but only an analysis of the embedded system and an external influence on the input data.

The method according to the disclosure can comprise the following steps, which are preferably performed sequentially and/or repeatedly, preferably during an operation of the machine learning model for a safety-critical application, e.g. a classification of images for controlling a vehicle:
ascertaining a monitoring input, the monitoring input being based on at least one intermediate result of the machine learning model preferably generated therefrom, preferably without taking into account the final result of the machine learning model,
evaluating the ascertained monitoring input by means of a monitoring system,
detecting the at least one physical attack on the basis of the evaluation.

This has the advantage that it is possible to react reliably to a physical attack, but at the same time the technical effort required for protection is reduced, especially in comparison to known countermeasures to physical attacks, in which the area consumption of a chip can at least triple. The at least one physical attack can comprise an attack which aims to ascertain a number of layers and/or activation functions and/or weights of the machine learning model. For this purpose, the attack can, e.g., analyze physical information such as a runtime and/or an electromagnetic radiation and/or a power consumption of the embedded system, preferably a chip of the embedded system. This is particularly the case if the at least one physical attack comprises a side-channel attack. The at least one physical attack can also comprise an fault injection attack, in which bit errors, in particular bit flips, are injected into the embedded system or chip.

The aforementioned analysis, i.e., ascertaining of the monitoring input and/or the evaluation of the ascertained monitoring input and/or the detection of the at least one physical attack, can take place outside of an operation of the machine learning model in the field, i.e. “offline”, e.g. not while driving, but rather in the laboratory.

Advantageously, in the context of the disclosure, it can be provided that the monitoring system comprises a further machine learning model which performs the evaluation of the ascertained monitoring input, the further machine learning model preferably being designed as an embedded neural network. The other machine learning model preferably comprises recurrent structures. The additional machine learning model can also comprise fewer neurons than the embedded machine learning model being protected. In other words, the additional machine learning model can be smaller than the model being protected, reducing the technical effort required for protection. The monitoring system or the additional machine learning model can be executed and provided by the same embedded system as the machine learning model being protected.

In addition, it can be provided that the machine learning model is designed as a neural network, preferably as a deep neural network, preferably trained for a safety-critical application in a vehicle. For example, it is possible that the machine learning model is trained to classify images of a vehicle. For this purpose, an embedded system of the vehicle can execute the machine learning model and use image data as input for the machine learning model. The image data can result from detection by a sensor, preferably a radar sensor, of the vehicle. It is possible to control the vehicle, e.g. accelerate and/or decelerate and/or steer the vehicle, on the basis of an output from the machine learning model applied in this way. For example, an autonomous driving function and/or a driver assistance system can evaluate the output and perform the control process. The vehicle is, e.g., a motor vehicle and/or a passenger vehicle and/or an autonomous vehicle.

It is also conceivable that the monitoring input comprises the at least one intermediate result and/or at least one output from an intermediate layer of the neural network (being protected). It is also possible that a plurality of intermediate results are provided, which correspond to different outputs of different intermediate layers of the neural network. Furthermore, ascertaining the monitoring input can comprise the following step: determining a feature activation, preferably in the form of an activation vector, the feature activation preferably being determined by a dimensional reduction, preferably summation, of the at least one output. The feature activation can be used as an input for another machine learning model of the monitoring system.

Furthermore, it is conceivable within the scope of the disclosure that the respective output from the intermediate layer comprises a plurality of feature cards, whereby the dimensional reduction for the respective output comprises the following step: calculating a value, preferably a total value, for each of the feature cards, which is specific to the entire respective feature card, the feature activation comprising the calculated values. It is thereby possible for the feature activation to represent the feature cards with a smaller amount of data.

Furthermore, it is conceivable that at least one of the following steps is provided in the method according to the disclosure:
detecting an error, preferably a bit error, during an execution of the machine learning model based on the evaluation, particularly preferably providing a corrected output from the machine learning model,
detecting an anomaly during the execution of the machine learning model based on the evaluation,
detecting a high prediction uncertainty of the (monitored) machine learning model based on the evaluation.
   Accordingly, the neural network of the monitoring system can have been trained to detect such faults or conditions.

It is also conceivable that a countermeasure, preferably a termination of an operation of the machine learning model and/or a blocking of inputs for the machine learning model, is initiated based on a result of the detection of the at least one physical attack. The attack can thereby be prevented from continuing in order to protect the machine learning model.

Furthermore, the machine learning model and preferably also the monitoring system can be executed on the embedded system. This enables a reliable application for a safety-critical function of a vehicle, for example.

A further advantage within the scope of the disclosure can be achieved if the at least one physical attack is detected both in the form of a side-channel attack and in the form of a fault injection attack on an embedded system. For this purpose, the neural network of the monitoring system can be trained to detect both types of attack. Alternatively or additionally, it is possible for the physical attack to be detected in the form of a physical intervention on the embedded system.

The disclosure also relates to a computer program, in particular a computer program product comprising instructions that, when the computer program is executed by a computer, prompt said computer program to perform the method according to the disclosure. The computer program according to the disclosure thus brings with it the same advantages as have been described in detail with reference to a method according to the disclosure.

An object of the disclosure is also a device for data processing, which is configured to perform the method according to the disclosure. The device can, e.g., be a computer and/or the embedded system which executes the computer program according to the disclosure. The computer can comprise at least one processor for executing the computer program. A non-volatile data memory can also be provided, in which the computer program can be stored and from which the computer program can be read by the processor for execution.

The disclosure can also relate to a computer-readable storage medium which comprises the computer program according to the disclosure. The storage medium is, e.g., designed as a data store, such as a hard drive and/or a non-volatile memory and/or a memory card. The storage medium can, e.g., be integrated into the computer.

The method according to the disclosure can moreover also be executed as a computer-implemented method.

### BRIEF DESCRIPTION OF THE DRAWINGS

Further advantages, features, and details of the disclosure will emerge from the following description, in which exemplary embodiments of the disclosure are described in detail with reference to the drawings. In this context, the features specified in the claims and in the description can each be essential to the disclosure, individually or in any desired combination. Shown are:

FIG. 1 a neural network of a monitoring system for detecting side-channel and fault injection attacks according to exemplary embodiments of the disclosure.

FIG. 2 a neural network of a monitoring system for correcting network output and detecting fault injection attacks according to exemplary embodiments of the disclosure.

FIG. 3 a schematic illustration of a method, a device, and a computer program according to exemplary embodiments of the disclosure.

In the drawings, identical reference signs are used for identical technical features, even in different exemplary embodiments.

### DETAILED DESCRIPTION

Various techniques are already available in the prior art for protection against side-channel attacks. Hiding countermeasures aim to conceal the actual power consumption of an integrated circuit (IC) by randomization in the time or amplitude domain. This can, among other ways, be achieved by dynamic clock frequency modification [6], by randomly changing the execution order (referred to as shuffling) or by dedicated noise generators [5]. Other types of countermeasures based on masking randomly split the data path into a plurality of parts to make the power consumption independent of the actual calculated data. Typically, each variable is represented as an n-tuple, with the sum (or bitwise XOR operation) of the parts giving the original data value (see [3, 4]).

For the detection of bitflips in memories and data paths of a digital hardware circuit, there are approaches from the area of functional safety as part of the protection against random hardware faults. For example, parts of the hardware can be duplicated and operated in lockstep method to detect such faults. Checksum methods can still be used for the linear part of the DNN calculations. Since the appearance of bitflips caused by hardware faults and those provoked by fault injection attacks are similar, these methods can also be used accordingly for protection against physical attacks.

Conventional countermeasures against physical attacks require many resources. For example, the space consumption and latency of the solution described in [4] (hardware masking) are more than twice as high as those of an unprotected DNN hardware accelerator. Known solutions are also very strongly adapted to the conditions of the embedded DNN and therefore cannot be flexibly combined with different DNN network architectures. Thus, [3, 4] can only be applied to Binarized Neural Networks (BNNs). Furthermore, conventional countermeasures against physical attacks are designed per se either to defend against side-channel attacks or to protect against fault injection attacks. In other words, a plurality of countermeasures must be combined to ensure comprehensive protection against physical attacks. This not only further increases the consumption of resources, but the combination of independently developed concepts can also lead to unwanted side effects, which in turn make the overall system unsafe.

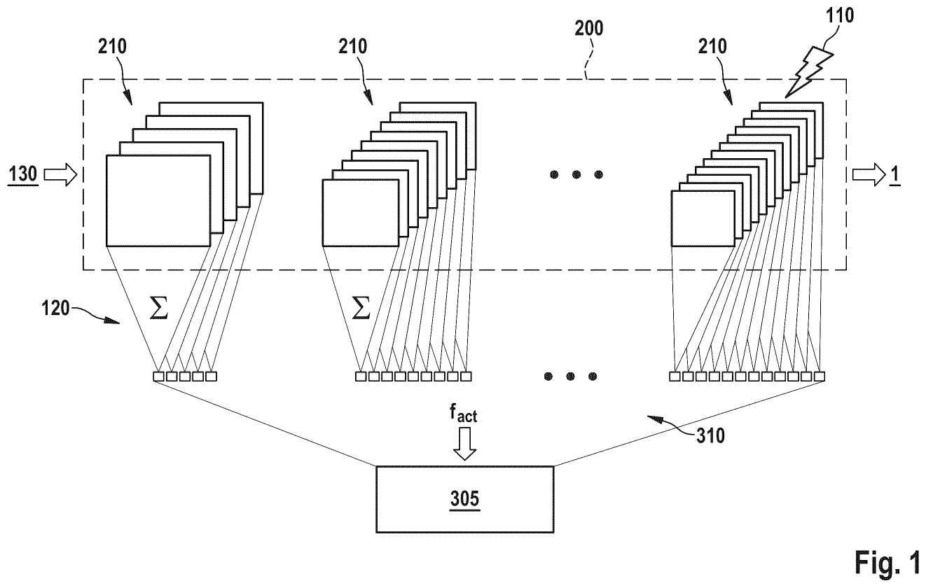

The method 100 proposed according to exemplary embodiments of the disclosure and illustrated in FIGS. 1 to 3 enables resource-efficient detection of both side-channel and fault injection attacks on embedded DNNs. The basis for this can be a functional system comprising a neural network 305 (hereinafter also referred to as the monitoring system 300 for ease of reference). This monitoring system 300 can be operated in parallel with the embedded machine learning model 200 being protected, e.g. a classification network, preferably an image classification network. The neural network 305 of the monitoring system 300 can be “smaller” than the machine learning model 200, thus having, e.g., fewer weights and/or layers. The monitoring system 300 can receive as input intermediate results 210 in the form of intermediate values (referred to as activation values) of the machine learning model 200 to detect whether there are anomalies and/or deviations from normal operation.

The monitoring system 300 can be based on the methods proposed in [8, 9], but in contrast to the conventional methods for detecting and mitigating physical attacks. In contrast to known countermeasure concepts against physical attack, the solution described according to exemplary embodiments of the disclosure provides a combined protective effect against side-channel and fault injection attacks without having to adapt the architecture or implementation of the machine learning model 200, preferably DNNs, being protected.

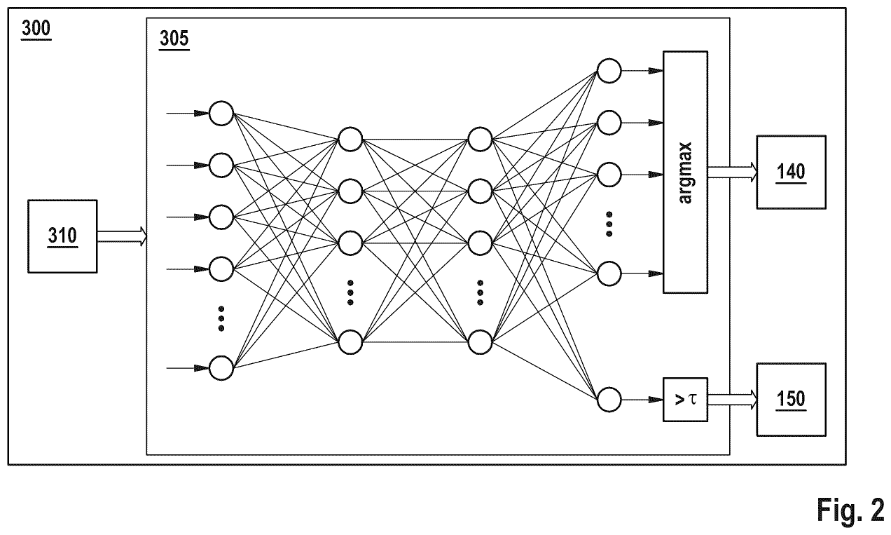

It is an idea of the disclosure that the second, significantly smaller neural network 305 of the monitoring system 300 is used in parallel to the machine learning model 200 in order to monitor the operations of the machine learning model 200. In this case, as shown in FIG. 2, a countermeasure, preferably a termination of an operation of the machine learning model 200 and/or a blocking of inputs 130 for the machine learning model 200, can be initiated based on a result 150 of the detection 103 of the at least one physical attack. Specifically, when the attack is detected, e.g. in the form of a side-channel attack according to exemplary embodiments of the disclosure, a corresponding interrupt can be thrown as a countermeasure, which stops the operation of the machine learning model 200. As a result, an attacker no longer has the option of measuring side channel information which can, e.g., lead to reverse engineering of weights, etc.

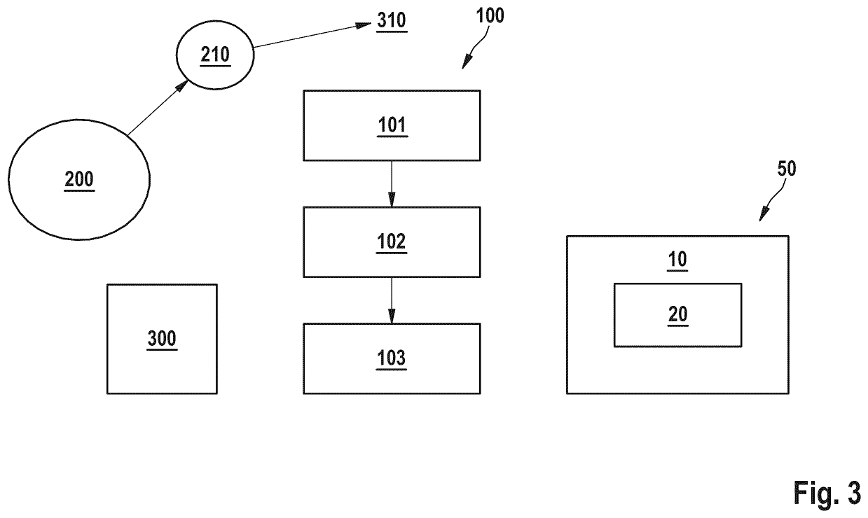

Fault injection attacks lead to targeted bit flips in the hardware, i.e., in particular the embedded system 50 (illustrated in FIG. 3) with which the machine learning model 200 is operated, and changes in the output data. An attacker can exploit the changes to the output data to extract weights. The monitoring system 300 can be able to detect and correct these bitflips so that the output data of the machine learning model 200 being protected does not provide an attacker with information for an attack. The implementation effort and thus resource consumption can be significantly lower than with known solutions, since the neural network 305 of the monitoring system 300 can be many times smaller than the machine learning model 200 being protected. Furthermore, the monitoring system can not be limited to the detection of physical attacks, but can also be used to correct random faults (safety) and detect other anomalies (e.g., unusual lighting conditions) when operated in the field. Accordingly, as shown in FIG. 2, a detection of a fault 110, preferably a bit error, by the monitoring system 300 during an execution of the machine learning model 200 can be provided, whereby a corrected output 140 of the machine learning model 200 can be provided.

An overview of the method 100 according to exemplary embodiments of the disclosure is shown in FIG. 1. Based on the intermediate results 210 of the monitored machine learning model 200, preferably DNNs, a feature activation f_{act}, which can be a vector or a multi-dimensional tensor, can be calculated. These tensors can be generated from an input example. In the case of 2D filters (convolution), which are usually used in DNNs for image classification, the output from an intermediate layer consists of a plurality of 2D feature maps that correspond to the various filter kernels of the layer. The term “feature map” is also referred to as a feature map in the context of the disclosure. For each feature map, a single value can be appended to f_{act} by adding up all the values of the feature map. Based on f_{act}, one or a plurality of predictions of the monitored machine learning model 200 can then be checked for anomalies and bit errors. In other words, the further machine learning model 200 of the monitoring system 300 can also be trained to detect such anomalies and bit errors. A binary output from the monitoring system can be provided to indicate whether an attack or anomaly has been detected in the machine learning model 200. A scalar output of the monitoring system can also be provided with, e.g., a value between 0 and 1, which indicates the probability of a detected attack.

In order to learn the association between f_{act} and anomaly or bit error, the monitoring system 300 can use a machine learning model 305, e.g., again an artificial neural network 305 such as a recurrent neural network. In principle, the monitoring system can be implemented using any desired ML algorithms. However, neural networks with recurrent structures, known as recurrent neural networks (RNNs), are particularly suitable for detecting physical attacks. In contrast to classical feedforward networks, neurons in RNNs not only have connections to neurons of subsequent layers, but also connections to neurons of the same layer or previous layers. As a result, the network is able to recognize and exploit temporary dependencies between input data. This feature is particularly useful for detecting side-channel attacks, as an attacker usually transfers a large amount of input data to the machine learning model 200 one after the other.

Typically, an attacker will not use image data, using which the monitored network was originally trained, but randomly distributed in input data. In this way, the entropy between successive input data is increased. The background to this is that with random input data, significantly more registers in the hardware change their state between two successive inputs. Dynamic power consumption is thereby increased, which has a favorable effect on side channel attacks. In the case of continuous image or video data, large proportions of successive input data are static, which means that only very few registers in the hardware change their state and have an impact on the dynamic (data-dependent) power consumption. If the monitoring system 300, in particular the neural network 305 of the monitoring system 300, now recognizes that intermediate values are calculated in the monitored machine learning model 200 that follow a distribution similar to random input data or a different distribution than valid input data (e.g., because a certain threshold value has been exceeded), the monitoring system 300 can detect the attack and initiate a countermeasure, e.g. block the monitored network 200 for further inputs, whereby no further side channel information can be extracted. In other words, the neural network 305 of the monitoring system 300 can be trained to recognize random input data of the machine learning model 200 to detect the attack.

In the case of error injection attacks, the attacker only needs one incorrect output to extract information about weights or the like. When a bit error is detected, either the result corrected by the monitoring system 300 is therefore used as the output date (see FIG. 2) or a statically predefined value (e.g., all outputs zero). A prerequisite for the detection and correction of bit errors can be that the neural network 305 of the monitoring system 300 has been trained using corresponding feature activation traces (generated, for example, by simulated bitflips) and that all output paths of the monitored machine learning model 200 are also present in the network 305 of the monitoring system 300 (for output correction). The detection accuracy can also be increased in this case by, e.g., using an RNN for detection (many bit errors in succession in this context means a higher probability of a fault injection attack). In other words, the neural network 305 of the monitoring system 300 can be trained to evaluate a frequency of bit errors in the machine learning model 200 in order to detect the attack.

Unlike conventional methods, the monitoring system 300 can be applied to protect against physical attacks on machine learning models 200 such as DNNs (as opposed to detecting random hardware faults). Protection can be understood to mean recognizing and optionally fending off such attacks. Furthermore, it is possible that the monitoring system 300 provides for the detection of physical attacks by means of a plurality of feature activation traces in order to increase the accuracy of the detection. For this purpose, an RNN can be used as the neural network of the monitoring system 300. In addition, combined detection of side-channel and fault injection attacks can be possible via different outputs of the monitoring system 300. For this purpose, the method according to exemplary embodiments of the disclosure can use the intermediate outputs of the monitored machine learning model 200, preferably a task DNN, perform a dimensional reduction 120 illustrated in FIG. 1 thereon (e.g., summation), and feed the resulting activation vector to an ML model 305 of the monitoring system 300 for detecting side channel and/or fault injection attacks.

FIG. 3 shows the method steps of a method 100 according to exemplary embodiments of the disclosure. The method is used to protect an embedded machine learning model 200 from at least one physical attack. In this context, the term “embedded” can mean that the machine learning model 200 is executed by an embedded system, i.e., in particular a processor of the embedded system 50. For this purpose, the machine learning model 200 (in trained form) can be permanently integrated into the embedded system 50, e.g. by means of an unalterable electronic data memory (not explicitly shown). According to a first method step 101, ascertainment of a monitoring input 310 can be provided, whereby the monitoring input 310 is based on at least one intermediate result 210 of the machine learning model 200. Then, according to a second method step 102, the ascertained monitoring input 310 can be evaluated by a monitoring system 300. Subsequently, according to a third method step 103, the at least one physical attack can be detected on the basis of the evaluation 102.

As shown in FIGS. 1 and 2, the monitoring system 300 can comprise a further machine learning model 305, which performs the evaluation 102 of the ascertained monitoring input 310. The machine learning model 200 can be designed as a neural network, preferably as a deep neural network, preferably trained for a safety-critical application in a vehicle (not explicitly shown). Further, as illustrated in FIG. 1, the at least one intermediate result 210 can comprise at least one output from an intermediate layer of the neural network, whereby ascertaining 101 the monitoring input 310 comprises determining a feature activation f_{act}, preferably in the form of an activation vector. The feature activation f_{act} can be determined by a dimension reduction 120 of the at least one output.

Furthermore, FIG. 1 schematically shows a computer program 20 and a device 10 for data processing according to exemplary embodiments of the disclosure. The device 10 can, e.g., be designed as the embedded system 50.

The explanation hereinabove of the embodiments describes the present disclosure solely within the scope of examples. Of course, individual features of the embodiments can be freely combined with one another, if technically feasible, without leaving the scope of the present disclosure.

### REFERENCES

[1] Lejla Batina, Shivam Bhasin, Dirmanto Jap, and Stjepan Picek. Csi neural network: Using side-channels to recover your artificial neural network information. Cryptology ePrint Archive, Report 2018/477, 2018. https://ia.cr/2018/477.
[2] Jakub Breier, Dirmanto Jap, Xiaolu Hou, Shivam Bhasin, and Yang Liu. Sniff: Reverse engineering of neural networks with fault attacks. IEEE Transactions on Reliability, pages 1-13, 2021.
[3] Anuj Dubey, Rosario Cammarota, and Aydin Aysu. Bomanet: Boolean masking of an entire neural net-work. In Proceedings of the 39th International Conference on Computer-Aided Design, ICCAD '20, New York, NY, USA, 2020. Association for Computing Machinery.
[4] Anuj Dubey, Rosario Cammarota, and Aydin Aysu. Maskednet: The first hardware inference engine aiming power side-channel protection. In 2020 IEEE International Symposium on Hardware Oriented Security and Trust (HOST), pages 197-208, 2020.
[5] I. Frieslaar and B. Irwin. Developing an electromagnetic noise generator to protect a raspberry pi from side channel analysis. SAIEE Africa Research Journal, 109(2):85-101, 2018.
[6] Benjamin Hettwer, Kallyan Das, Sebastien Leger, Stefan Gehrer, and Tim Güneysu. Lightweight sidechannel protection using dynamic clock randomization. In 2020 30th International Conference on Field-Programmable Logic and Applications (FPL), pages 200-207, 2020.
[7] Stefan Mangard, Elisabeth Oswald, and Thomas Popp. Power Analysis Attacks: Revealing the Secrets of Smart Cards. Springer Publishing Company, Incorporated, 1st edition, 2010.
[8] Christoph Schorn and Lydia Gauerhof. Facer: A universal framework for detecting anomalous operation of deep neural networks. In 2020 IEEE 23rd International Conference on Intelligent Transportation Systems (ITSC), pages 1-6, 2020.
[9] Christoph Schorn. Andre Guntoro, and Gerd Ascheid. Efficient on-line error detection and mitigation for deep neural network accelerators. In Barbara Gallina, Amund Skavhaug, and Friedemann Bitsch, editors, Computer Safety, Reliability, and Security, pages 205-219. Cham. 2018. Springer International Publishing.

What is claimed is:

1. A method for protecting an embedded machine learning model from at least one physical attack, comprising:
ascertaining a monitoring input, wherein the monitoring input is based on at least one intermediate result from the machine learning model;
evaluating the ascertained monitoring input by way of a monitoring system; and
detecting the at least one physical attack on the basis of the evaluation,
wherein the monitoring system comprises a further machine learning model which is configured to perform the evaluation of the ascertained monitoring input, and
wherein the further machine learning model comprises fewer neurons than the embedded machine learning model being protected.

2. The method according to claim 1, wherein the further machine learning model is designed as an embedded neural network.

3. The method according to claim 1, wherein the machine learning model is designed as a neural network.

4. The method according to claim 3, wherein:
the at least one intermediate result comprises at least one output from an intermediate layer of the neural network,
the step of ascertaining the monitoring input comprises determining a feature activation in the form of an activation vector,
the feature activation is determined by a dimensional reduction of the at least one output, and
the feature activation is used as input for a further machine learning model of the monitoring system.

5. The method according to claim 4, wherein:
the respective output from the intermediate layer comprises a plurality of feature cards,
the dimensional reduction for the respective output comprises calculating a value for each of the feature cards which is specific to the entire feature card in question, and
the feature activation comprises the calculated values.

6. The method according to claim 1, further comprising at least one of the following steps:
detecting a fault during an execution of the machine learning model on the basis of the evaluation, wherein a corrected output from the machine learning model is particularly provided, and
detecting an abnormality in the execution of the machine learning model based on the evaluation.

7. The method according to claim 1 wherein a termination of an operation of the machine learning model and/or a blocking of inputs for the machine learning model is initiated based on a result of the detection of the at least one physical attack.

8. The method according to claim 1, wherein:
the at least one physical attack is detected, both in the form of a side-channel attack and in the form of a fault injection attack, on an embedded system, and
the machine learning model is executed on the embedded system.

9. The method according to claim 1, wherein:
the physical attack is detected in the form of a physical intrusion on an embedded system, and
the machine learning model is executed on the embedded system.

10. A computer program comprising instructions which, when the computer program is executed by a computer, prompt the latter to perform the method according to claim 1.

11. A device for data processing which is configured to perform the method according to claim 1.

12. The method according to claim 1, wherein the further machine learning model is designed as an embedded neural network and comprises recurrent structures.

13. The method according to claim 1, wherein the machine learning model is designed as a deep neural network.

14. The method according to claim 3, wherein the dimensional reduction is a summation.

15. The method according to claim 4, wherein the value is a total value.

16. The method according to claim 6, wherein the fault is a bit error.

17. The method according to claim 1, wherein a countermeasure is initiated based on a result of the detection of the at least one physical attack.

18. The method according to claim 1, wherein:
the at least one physical attack is detected, both in the form of a side-channel attack and in the form of a fault injection attack, on an embedded system, and
the machine learning model and also the monitoring system are executed on the embedded system.

19. The method according to claim 1, wherein:
the physical attack is detected in the form of a physical intrusion on an embedded system, and
the machine learning model and also the monitoring system are executed on the embedded system.
